(19) United States
(12) Patent Application Publication
(10) Pub. No.: US 2017/0006088 A1
(43) Pub. Date: Jan. 5, 2017

(54) CONNECTION METHOD AND COMMUNICATION DEVICE

(71) Applicant: FUJITSU LIMITED, Kawasaki-shi (JP)

(72) Inventor: Tomoyuki Tsunoda, Kawasaki (JP)

(21) Appl. No.: 15/187,593

(22) Filed: Jun. 20, 2016

(30) Foreign Application Priority Data
Jul. 3, 2015 (JP) 2015-134723

(51) Int. Cl. H04L 29/08; H04L 12/26; H04L 12/44

(52) U.S. Cl. CPC H04L 67/104; H04L 12/44; H04L 67/322; H04L 43/16; H04L 67/14

(57) ABSTRACT

A first communication device compares communication quality between a target communication device selected from among communication devices having a possibility of becoming a connection destination and the first communication device, with a quality threshold. The first communication device obtains the quality threshold as a function of data reception quality in the target communication device and a number of communication devices to which connections were attempted by the first communication device excluding the target communication device. The first communication device sets the quality threshold as a detection threshold for detecting an opportunity to change a connection destination when the communication quality is equal to or higher than the quality threshold. The first communication device determines a second communication device with relatively high communication quality with the first communication device to be a connection destination used until the communication quality between the second and first communication devices falls below the detection threshold.

### CROSS-REFERENCE TO RELATED APPLICATION

This application is based upon and claims the benefit of priority of the prior Japanese Patent Application No. 2015-134723, filed on Jul. 3, 2015, the entire contents of which are incorporated herein by reference.

### FIELD

The embodiments discussed herein are related to a method for a connection between a communication device and a connection destination in a communication system.

### BACKGROUND

Peer-to-peer (P2P) communication processes performed between communication devices sometimes use a data distribution system in which data is distributed to a plurality of devices. Such a data distribution system sometimes uses a tree network having the data distribution source as its origin. Each communication device in a data distribution system monitors the reception quality and when the reception quality in itself has fallen below a prescribed threshold, it disconnects the communication with the connection destination and starts a communication with a different device that it can communicate with in the data distribution system.

FIG. 1 illustrates an example of a data distribution system. The data distribution system illustrated in FIG. 1 includes a server 5 and communication devices 1a through 1h, and the communication device 1h is assumed to be connected to the communication device 1f when a communication starts. The server 5 distributes data to the communication device 1a, and the communication device 1a transmits the data received from the server 5 to the communication devices 1b and 1c. The communication device 1b transmits the data received from the communication device 1a to the communication device 1f. Similarly, the communication device 1c transmits the data received from the communication device 1a to the communication devices 1d and 1e. Meanwhile, the communication device 1f transmits the data received from the communication device 1b to the communication devices 1g and 1h. In FIG. 1, the value appearing around each of the communication devices represents a percentage of data that has correctly been received by that communication device with respect to the data distributed from the server. For example, the communication devices 1a through 1d have correctly received 99% of the distributed data while the communication devices 1e through 1g have correctly received 98% of the distributed data. The communication device 1h has correctly received 94% of the distributed data.

It is now assumed that all communication devices have the thresholds (reception quality thresholds) set to 95% for determining whether or not the communication device is to change a connection destination. In such a case, each communication device does not change a connection destination when it is correctly receiving at least 95% of the distributed data, while it changes a connection destination when the percentage of correctly received data has fallen below 95%. In the example illustrated in FIG. 1, data received with the communication device 1h connected to the communication device 1f is 94% of the distributed data, making the communication device 1h determine to change a connection destination from the communication device 1f to a different device. Detecting that a connection to the communication device 1d is possible, the communication device 1h changes the connection destination to the communication device 1d as depicted by arrow A. In the example illustrated in FIG. 1, the communication device 1h receives data from the communication device 1d as depicted by arrow B after changing the connection destination to the communication device 1d, and is receiving 99% of the distributed data. Accordingly, the communication device 1h obtains data by treating the communication device 1d as a connection destination.

As a related art, a control method is proposed in which a node compares the value of the link quality with that of each of a plurality of neighboring nodes so as to treat a link with quality equal to or higher than a threshold as an authorized link. Also, a method is proposed in which when loads on a server have become equal to or greater than a threshold, an instruction is transmitted to switch the control method from a control method of ALM based on hybrid P2P to a control method of ALM based on pure P2P. In this method, a node on a higher layer transmits a switching instruction to a node on a lower layer in a tree broadcasting system.

Japanese National Publication of International Patent Application No. 2014-504089 and Japanese Laid-open Patent Publication No. 2009-232271 for example are known.

According to communication methods that change a connection destination when the data reception quality is lower than a threshold, a communication device that newly participates in a distribution system searches for a connection destination with higher reception quality until it finds a connection destination with reception quality equal to or higher than the threshold. This leads to a situation where a communication device in a bad communication state with respect to other communication devices continues to search for a connection destination without participating in the data distribution system, failing to obtain data. This deteriorates data distribution efficiency in a case when a communication device in a bad communication state is involved.

### SUMMARY

According to an aspect of the embodiments, a connection method is performed by a first communication device that participates in a distribution system including a plurality of communication devices. The first communication device compares communication quality between a target communication device selected from among communication devices having a possibility of becoming a connection destination for the first communication device and the first communication device, with a quality threshold. The first communication device obtains the quality threshold as a function of data reception quality in the target communication device and a number of communication devices to which connections were attempted by the first communication device excluding the target communication device. The first communication device sets the quality threshold as a detection threshold for detecting an opportunity to change a connection destination when the communication quality is equal to or higher than the quality threshold. The first communication device determines a second communication device with relatively high communication quality with the first communication device to be a connection destination used until the communication quality between the second and first communication devices falls below the detection threshold, from among communication devices having a possibility of becoming a connection destination for the first communication device.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 explains an example of a data distribution system;

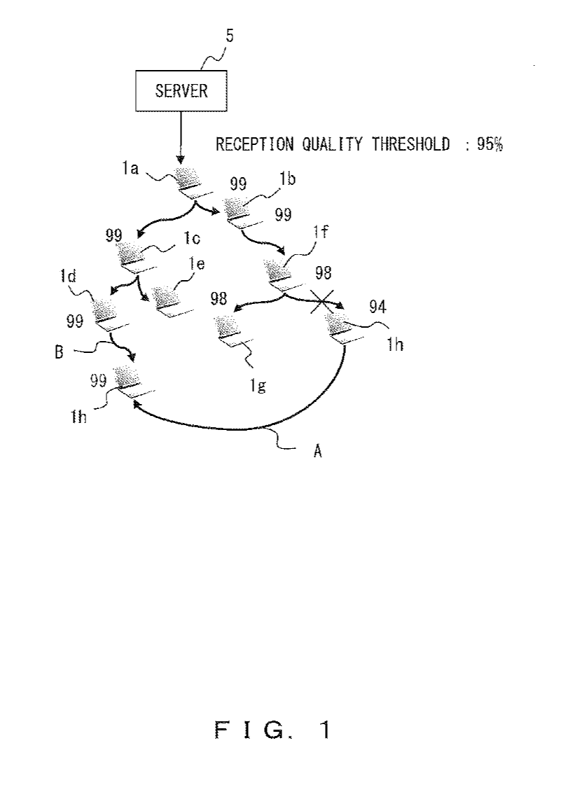

FIG. 2 is a flowchart explaining an example of a communication method according to an embodiment;

FIG. 3 illustrates an example of a configuration of a communication device;

FIG. 4 illustrates an example of a hardware configuration of the communication device;

FIG. 5 illustrates an example of a method of obtaining information of a connection destination;

FIG. 6 illustrates an example of a method of calculating reception quality;

FIG. 7 illustrates an example of a communication method according to an embodiment;

FIG. 8 illustrates examples of connection destination candidate lists and quality lists;

FIG. 9 illustrates examples of connection destination candidate lists and quality lists;

FIG. 10 is a flowchart explaining an example of a communication method according to an embodiment;

FIG. 11 illustrates an improved example of a data distribution system using a method according to an embodiment; and

FIG. 12 is a flowchart explaining an example of a communication method according to a variation example.

### DESCRIPTION OF EMBODIMENTS

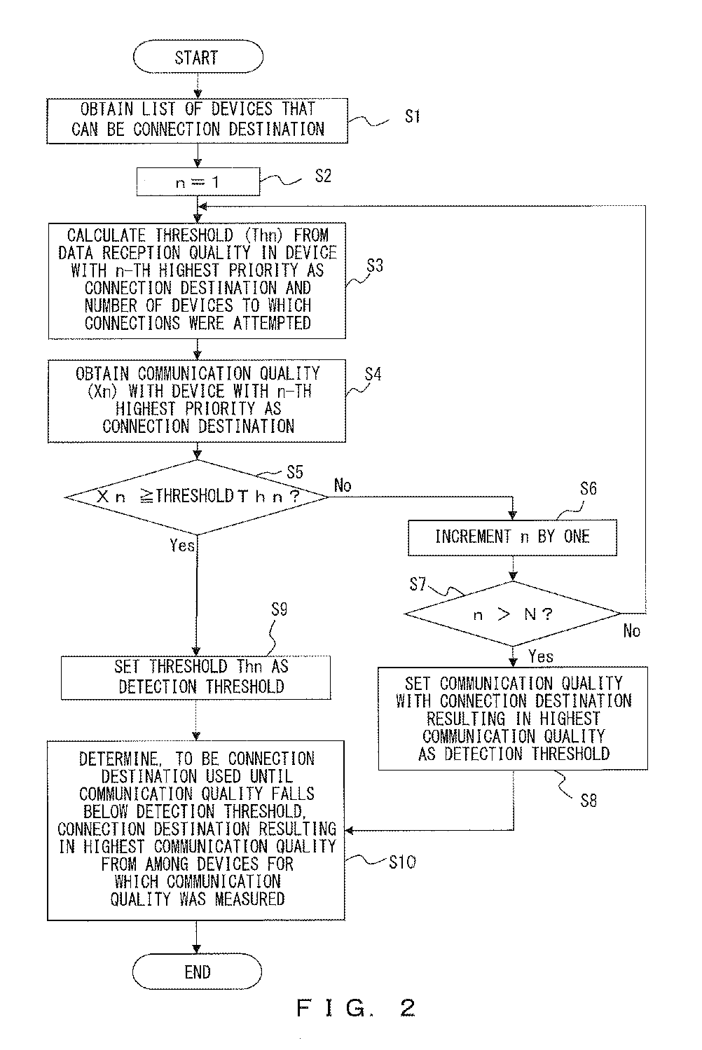

FIG. 2 is a flowchart explaining an example of a communication method according to an embodiment. In FIG. 2, variable n and constant N are used. In this example, variable n is the number of candidates for a connection destination that had their reception quality measured by communication devices 10 participating in a data distribution system, and constant N is the total number of the communication devices 10 that can be a connection destination.

The communication device 10 participating in the data distribution system obtains a list of the communication devices 10 that can be connection destinations (step S1). The communication device 10 participating in the data distribution system sets variable n to “1”, and calculates threshold Thn on the basis of the reception quality of data in the communication device with the n-th highest priority as a connection destination and the basis of the number of the devices to which connections were attempted by that moment (steps S2 and S3). In the calculation, the communication device 10 calculates the threshold so that the greater the number of the devices to which connections were attempted by that moment is, the smaller threshold Thn is.

The communication device 10 participating in the data distribution system obtains communication quality (Xn) for a case when the device with the n-th highest priority as a connection destination is selected as a connection destination (step S4). In this example, data reception quality for example is used as communication quality. The communication device 10 participating in the data distribution system compares communication quality Xn and threshold Thn, and increments variable n by one without treating the device with the n-th highest priority as a connection destination when threshold Thn is greater than communication quality Xn (No in step S5, step S6). When variable n is not higher than constant N, the processes in and subsequent to step S3 are repeated (No in step S7).

When communication quality Xn is equal to or higher than threshold Thn, the communication device 10 participating in the data distribution system sets, to the same value as threshold Thn, a threshold (detection threshold) used for detecting an opportunity for that communication device 10 to change a connection destination (Yes in step S5, step S9). Further, the communication device 10 determines, to be a destination used until the communication quality falls below the detection threshold, the connection destination with the highest communication quality among devices that have their reception quality measured (step S10).

Note that regarding communication with any connection destinations, when the communication quality is lower than the threshold, the communication device 10 sets, as the detection threshold, the communication quality with the connection destination resulting in the highest communication quality (Yes in step S7, step S8). Thereafter, the communication device 10 determines a connection destination by the process in step S10 (step S10).

As described above, a method according to an embodiment has each of the communication devices 10 change the detection threshold used for determining whether or not to change a connection destination in accordance with the number of the devices to which connections were attempted by that communication device 10 and the reception quality in the connection destination. This makes it possible for a device in a bad communication state with respect to a different communication device 10 to receive distributed data from a connection destination in a relatively good communication state by setting a small value as the detection threshold. Also, by setting a small value as the detection threshold, a device in a bad communication state with respect to a different communication device 10 is prevented from entering a situation in which that device fails to receive distributed data because of too high a frequency of searching for a connection destination.

<Device Configuration>

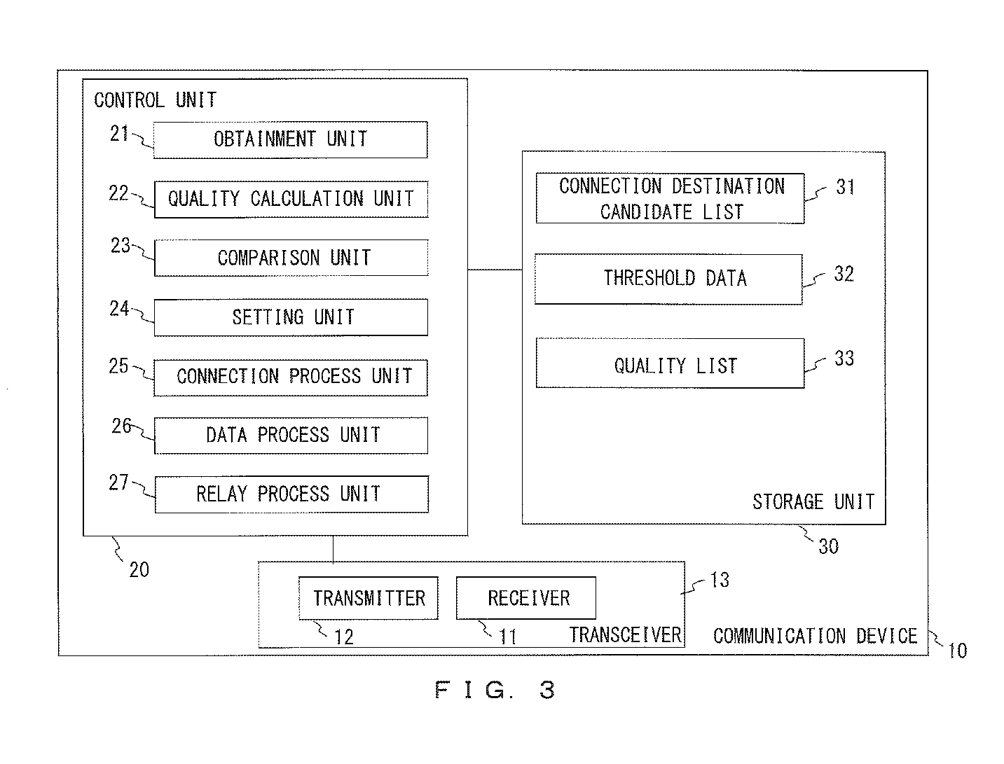

FIG. 3 illustrates an example of a configuration of the communication device 10. The communication device 10 includes a transceiver 13, a control unit 20 and a storage unit 30. The storage unit 30 stores connection destination candidate lists 31, threshold data 32 and quality lists 33. The control unit 20 includes an obtainment unit 21, a quality calculation unit 22, a comparison unit 23, a setting unit 24, a connection process unit 25, a data process unit 26 and a relay process unit 27.

The transceiver 13 includes a receiver 11 and a transmitter 12. The 11 receives a packet from a different device such as the server 5, other communication devices 10, etc. The transmitter 12 transmits a packet to a different device such as the server 5, other communication devices 10, etc.

The obtainment unit 21 uses a received packet so as to obtain the connection destination candidate list 31 or information that can be used for generating the connection destination candidate list 31, from a device in the data distribution system in which the device of the obtainment unit 21 is attempting to participate. In this example, the connection destination candidate list 31 is a list of the communication devices 10 that can be a connection destination for the device of the obtainment unit 21. The quality calculation unit 22 calculates the reception quality of the distributed data in the device of the quality calculation unit 22. The quality calculation unit 22 records the calculated reception quality in the quality list 33 on an as-needed basis. The comparison unit 23 calculates, when the device of the comparison unit 23 is searching for a connection destination, a threshold by using the reception quality in the communication devices 10 that are candidates for a connection destination and the number of the devices to which connections were attempted by the device of the comparison unit 23. The threshold calculated by the comparison unit 23 is stored in a storage unit 30 as threshold data 32 on an as-needed basis. Further, the comparison unit 23 compares the obtained threshold and the reception quality calculated by the quality calculation unit 22. When the reception quality calculated by the quality calculation unit 22 is equal to or higher than the threshold calculated by the comparison unit 23, the setting unit 24 sets the threshold used for the comparison process as the detection threshold.

The connection process unit 25 establishes connections to the communication devices 10 that are candidates for a connection destination or the communication device 10 selected as a connection destination from among the candidates for a connection destination. Further, the connection process unit 25 periodically compares the reception quality obtained by the quality calculation unit 22 and the detection threshold while it is in the data distribution system, and determines that it has detected an opportunity to change the connection destination when the reception quality has fallen below the detection threshold. The data process unit 26 processes distributed data received during the participation in the data distribution system. The relay process unit 27 performs, on the communication device 10 which obtains distribution-target data from the device of the relay process unit 27, a process for relaying the distribution-target data.

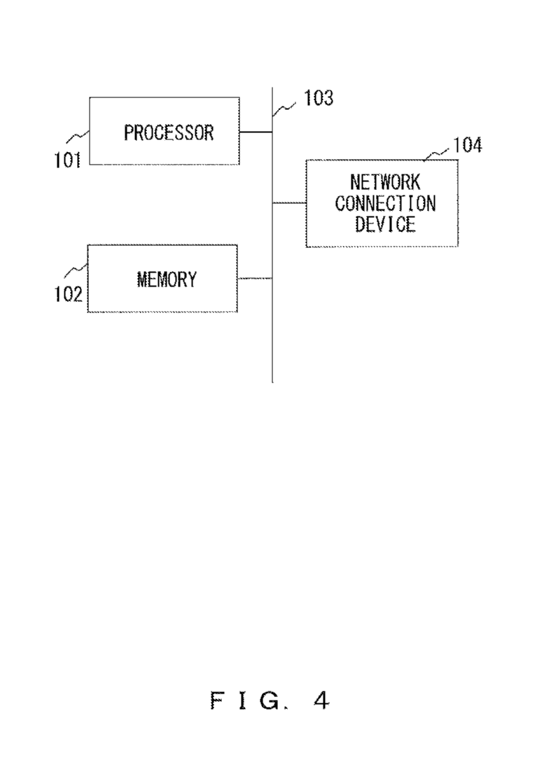

FIG. 4 illustrates an example of a hardware configuration of the communication device 10. The communication device 10 includes a processor 101, a memory 102, a bus 103 and a network connection device 104. The processor 101 is an arbitrary processing circuit including a central processing unit (CPU). The processor 101 uses the memory 102 as a working memory so as to execute a program and thereby performs various processes. The memory 102 includes a random access memory (RAM), and further includes a non-volatile memory such as a read only memory (ROM) etc. The bus 103 connects the processor 101, the memory 102 and the network connection device 104 so that data can be input to and output from each other. In the communication device 10, the processor 101 operates as the control unit 20 and the memory 102 operates as the storage unit 30. Further, the network connection device 104 realizes the transceiver 13. Note that the program may be provided in a form that it is stored in a non-transitory computer-readable recording medium and is installed in the communication devices 10.

### Embodiments

Hereinafter, an example of a process performed when a communication device 10 newly participates in a data distribution system will be explained as the obtainment of candidates for a connection destination in the data distribution system, the calculation of reception quality and the determination of a connection destination. Hereinafter, in order to clearly express which of the communication devices 10 is performing processes, a character identical to the identifier assigned to the communication device 10 may be added to the tail of the numerical symbol. For example, the obtainment unit 21h refers to the obtainment unit 21 included in the communication device 10h.

(1) Obtainment of Candidate for Connection Destination

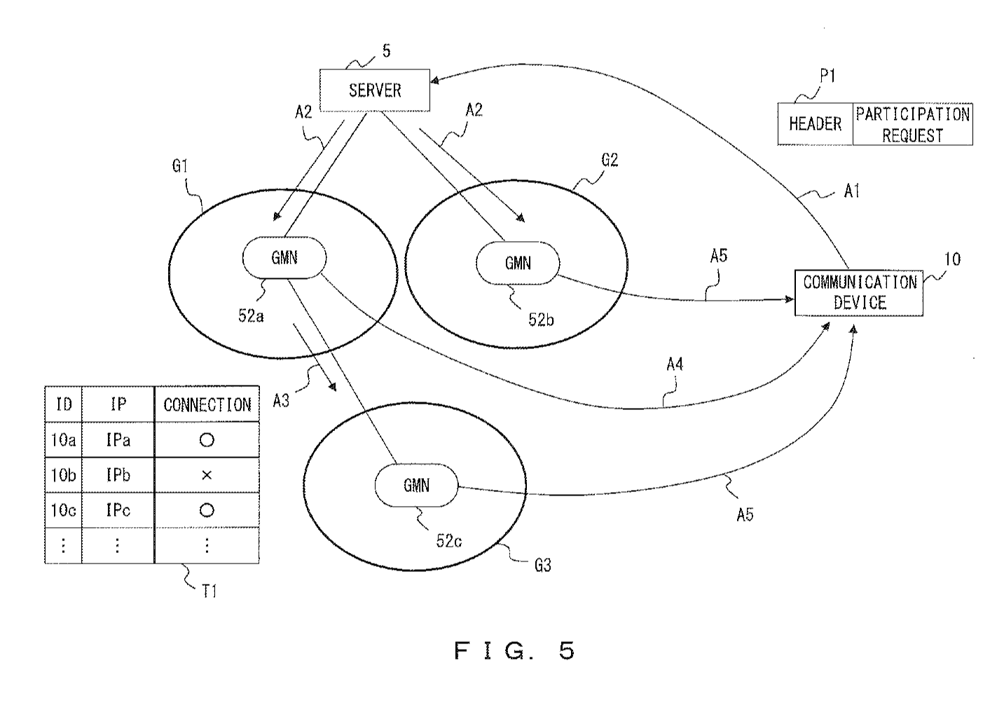

FIG. 5 illustrates an example of a method of obtaining information of a connection destination. The network illustrated in FIG. 5 includes the server 5 and three groups G1 through G3, whereas an arbitrary number of groups may be in the network. Each group includes an arbitrary number of the communication devices 10, the arbitrary number being at least one, and each group includes one group manager node (GMN) 52. The group manager node 52 is determined by the transmission of a control packet from the server 5 etc. to a communication device 10 that is to become a new group manager node 52 upon generation of a group, the control packet requesting that the communication device 10 operate as the group manager node 52. Each communication device 10 other than the group manager node 52 in a group periodically reports, to the group manager node 52 of the group to which that communication device 10 belongs, the number of the communication devices 10 connected to that communication device 10, the number of connections that the communication device 10 can form newly, the reception quality, etc. Note that each communication device 10 recognizes the total number of the devices to which that communication device 10 can be connected and the number of the devices to which that communication device 10 is currently connected, and calculates the number of the devices that can be connected newly from these values. Accordingly, each group manager node 52 can periodically obtain information of other communication devices 10 in the group to which that group manager node 52 belongs.

Table T1 illustrated in FIG. 5 is information, held by the group manager node 52a, on each of the communication devices 10 in group G1. Table T1 stores, for each device in the group, the ID, the IP (Internet Protocol) address and whether or not new connection is possible. The example of table T1 illustrates a case where group G1 includes the communication devices 10a through 10c, a new communication device 10 can be connected to the communication devices 10a and 10c while the connection of the new communication device 10 to the communication device 10b is not permitted.

FIG. 5 exemplifies a case where the group manager node 52a of group G1 and the group manager node 52b of group G2 are directly connected to the server 5 and the group manager node 52c of group G3 is connected to the group manager node 52a. Note that FIG. 5 exemplifies a case where the group manager node 52 is connected to another group manager node 52 or the server 5, whereas the group manager node 52 can also be connected to devices other than the another group manager node 52 or the server 5.

When the communication device 10 attempts to participate in the data distribution system illustrated in FIG. 5, the communication device 10 transmits participation request packet P1 to the server 5 (arrow A1). Participation request packet P1 includes a header and information indicating that the communication device 10 requests that it participate in the data distribution system.

The server 5 transfers received participation request packet P1 to the group manager node 52 of the group including a node connected to the server 5. In the example illustrated in FIG. 5, the server 5 transfers participation request packet P1 to the group manager node 52a and the group manager node 52b (arrows A2). When another group is connected on the downstream side of the group manager node 52, it transfers participation request packet P1 to the group manager node 52 of that group on the downstream side. For example, the group manager node 52a transfers participation request packet P1 to the group manager node 52c of group G3 (arrow A3). Through this process, participation request packet P1 is transferred to the group manager nodes 52 of all groups in the data distribution system.

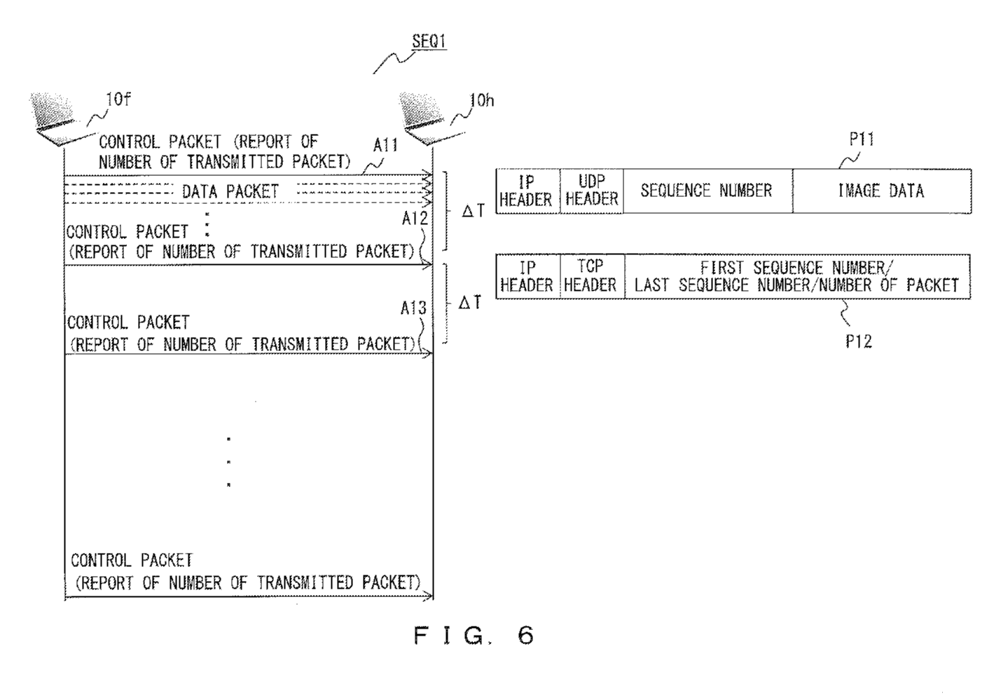

The group manager node 52 that have obtained participation request packet P1 reports, to the transmission source of participation request packet P1, information of the communication device 10 to which a new connection can be established from among the communication devices 10 in the group that includes the group manager node 52 itself. For example, the group manager node 52a transmits, to the communication device 10 that transmitted participation request packet P1, the fact that connections can be established to the communication devices 10a and 10c and the IP addresses of the communication devices 10a and 10c by referring to table T1 (arrow A4). The group manager node 52a also reports, to the communication device 10 that transmitted participation request packet P1, the reception quality in each device that is a candidate for a connection destination. How to obtain reception quality will be explained by referring to FIG. 6. Similarly to the group manager node 52a, the group manager nodes 52b and 52c of other groups also transmit, to the communication device 10 that transmitted participation request packet P1, the IP addresses of devices to which connections can be established in the group of each of the group manager nodes 52b and 52c and the reception quality in such devices (arrows 5).

The communication devices 10 receives, from each group manager nodes 52, a packet reporting information of the communication device 10 that can be connected. Obtaining the received packet via the receiver 11, the obtainment unit 21 of the communication device 10 extracts, from the received packet, information of a device that is to be a candidate for a connection destination, and stores it in the connection destination candidate list 31.

(2) Method of Calculating Reception Quality

FIG. 6 illustrates an example of a method of calculating reception quality. By referring to FIG. 6, explanations will be given for an example of a method of calculating reception quality conducted by a device that is in a data distribution system or that is attempting to participate in a data distribution system. In the example illustrated in FIG. 6, a device that distributes distribution data transmits a data packet and a control packet to a device as a distribution destination. Note that examples of devices that distribute distribution data include, in addition to the server 5, the communication devices 10 that transmit distribution data to another communication device 10. In the example of P11 illustrated in FIG. 6, a data packet distributed by the data distribution system includes image data. As depicted as P11, the data packet includes an IP header, an UDP (User Datagram Protocol) header, a sequence number and distribution-target image data. The sequence number represents the order of the image data that is being distributed. Note that the sequence number is included in the packet as information included in the payload.

Meanwhile, the control packet is a packet transmitted for reporting the number of the data packets transmitted during a prescribed period of time, and is transmitted for each prescribed period (ΔT). The control packet includes, as depicted as P12, an IP header, a TCP (Transmission Control Protocol) header and a control data. The control data includes the value of the first number of the sequence number included in a data packet that was transmitted after the transmission of the immediately previous control packet, the value of the last number of the sequence number included in the transmitted data packet, and the number of the transmitted packets.

Sequence SEQ1 illustrated in FIG. 6 illustrates an example of a transmission timing for a control packet and a data packet in an exemplary case where data is distributed from the communication device 10f to the communication device 10h. In sequence SEQ1, the transmission of a control packet is represented by a solid arrow, and the transmission of a data packet is represented by a dashed arrow.

It is assumed for example that the relay process unit 27f of the communication device 10f has generated a control packet upon the start of data distribution so as to transmit it to the communication device 10h via the transmitter 12f (arrow A11). Because no data packet had been transmitted before the transmission of the control packet represented by arrow A11, the control packet transmitted from the communication device 10f as represented by arrow A11 includes the following pieces of information.

The first sequence number: 0
The last sequence number: 0
The number of transmitted packets: 0

It is assumed that by a process performed by the relay process unit 27f of the communication device 10f, data packets with the sequence numbers 1 through 100 were thereafter transmitted from the communication device 10f to the communication device 10h. The quality calculation unit 22h of the communication device 10h obtains the data packets via the receiver 11h so as to store the sequence numbers extracted from the obtained data packets. In this example, it is assumed that the communication device 10h received the data packets with the sequence number of 1 and with the sequence numbers of 3 through 100. Then, because the quality calculation unit 22h has the sequence numbers of 1 and 3 through 100 stored therein, and accordingly the number of the stored sequence numbers is 99.

When transmission period (ΔT) for a control packet has elapsed since the transmission time of day of the previous control packet, the communication device 10f generates a control packet including the following pieces of information, and transmits the packet to the communication device 10h (arrow A12).

The first sequence number: 1
The last sequence number: 100
The number of transmitted packets: 100

The quality calculation unit 22h in the communication device 10h obtains the control packet via the receiver 11h and obtains the number of the data packets transmitted between the control packet received previously and the control packet transmitted this time and also obtains the sequence numbers. While 100 data packets were transmitted between the control packet received as represented by arrow A11 and the control packet received as represented by arrow 12, the quality calculation unit 22h holds the sequence numbers of only 99 data packets. In response to this situation, the quality calculation unit 22h calculates, as the reception quality, a ratio of the received data packet to the total number of the transmitted data packet. In this example, 99 data packets have been received against the transmission of 100 data packets, and accordingly the quality calculation unit 22h calculates 99% as the reception quality. Finishing the calculation of the reception quality, the quality calculation unit 22h resets the number of the received packets, and continues calculations of reception quality in a similar manner.

It is assumed for example that the communication device 10f transmitted the data packets with the sequence numbers of 101 through 200 toward the communication device 10h after the reception of the control packet as represented by arrow A12. It is also assumed that the communication device 10h received the data packets with the sequence numbers of 101 through 180 but did not receive the packets with the sequence number of 181 and the subsequent numbers. Then, the quality calculation unit 22h stores the fact that the 80 packets with the sequence numbers of 101 through 180 were received after the reception of the control packet as represented by arrow A12.

The communication device 10f generates a control packet including the following pieces of information so as to transmit it to the communication device 10h (arrow A13).

First sequence number: 101
Last sequence number: 200
The number of transmitted packets: 100

While 100 data packets were transmitted between the control packet received as represented by arrow A12 and the control packet received as represented by arrow A13, the quality calculation unit 22h has received only 80 data packets. Then, the quality calculation unit 22h calculates 80% as the reception quality because 80 data packets have been received against the transmission of 100 data packets. Note that transmission interval ΔT for control packets is determined in accordance with the implementation.

(3) Determination of Connection Destination

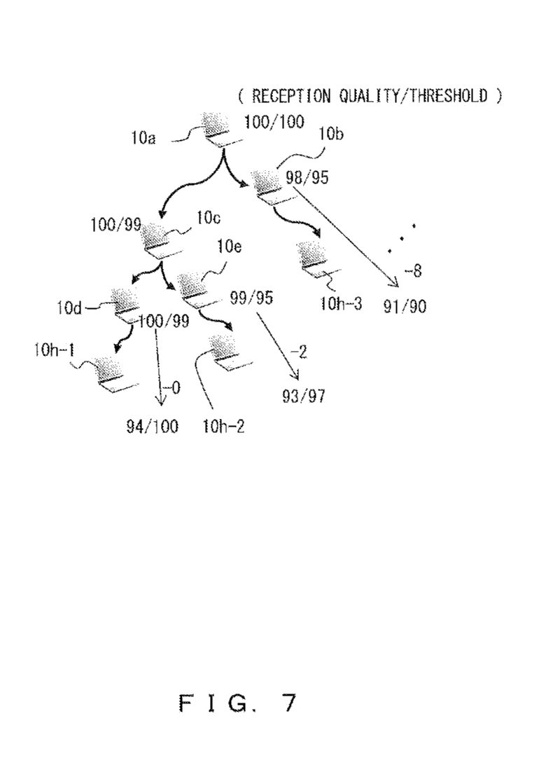

FIG. 7 illustrates an example of a communication method according to an embodiment. It is assumed hereinafter that the distribution system of data transmitted by the server 5 includes a plurality of devices including the communication devices 10a through 10g. Note that FIG. 7 illustrates only some of the communication devices 10 in the data distribution system. Regarding the communication devices 10a through 10e illustrated in FIG. 7, the reception quality and the value of the threshold for determining whether or not to change a communication destination in each of the devices are expressed by a string of numbers including a slash between them. The value left of a slash represents the reception quality of that communication device 10, while the value right of the slash represents the threshold used by that communication device 10. Reception quality or thresholds may vary depending upon the communication environments. For example, the communication device 10a has 100% both as the reception quality and the threshold. This makes the communication device 10a change a connection destination when the reception quality has fallen below 100%. The communication devices 10c and 10d have 100% as the reception quality and 99% as the threshold, which does not make them change a connection destination even when the reception quality has become 99.5%.

The communication devices 10h-1 through 10h-3 in FIG. 7 illustrate a situation where the communication devices 10h attempting to participate in the data distribution system are connected to candidates that have been reported as connection destinations. By referring to FIG. 7 through FIG. 9, explanations will be given for a process performed when the communication device 10 that is newly participating in the data distribution system determines a connection destination.

The obtainment unit 21h in the communication device 10h first generates a participation request requesting the participation to the data distribution system, and transmits it to the server 5 via the transmitter 12h. Then, by the process explained by referring to FIG. 5, information of the communication device 10 to which the communication device 10h can be connected is reported to the communication device 10h. The obtainment unit 21h in the communication device 10h uses the received packet so as to generate the connection destination candidate list 31h. In the explanations below, it is assumed that information of five of the communication devices 10, i.e., the communication device 10b and the communication devices 10d through 10g were reported to the connection destination candidate list 31h. In the explanations below, it is assumed that the IP addresses of 10.0.0.2, 192.168.10.2 and 192.168.10.3 are assigned to the communication devices 10b, 10d and 10e. It is also assumed similarly that the IP addresses of 192.168.11.2 and 192.168.11.3 are assigned to the communication devices 10f and 10g. Also, the IP address assigned to the communication device 10h is 192.168.10.100.

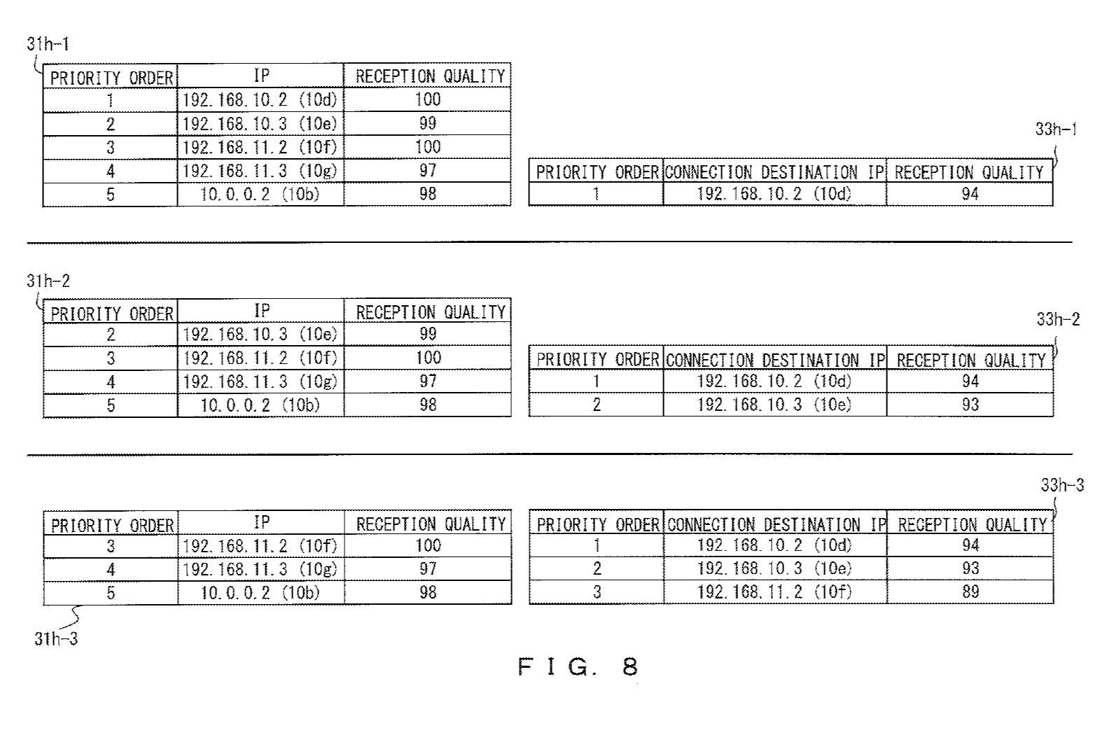

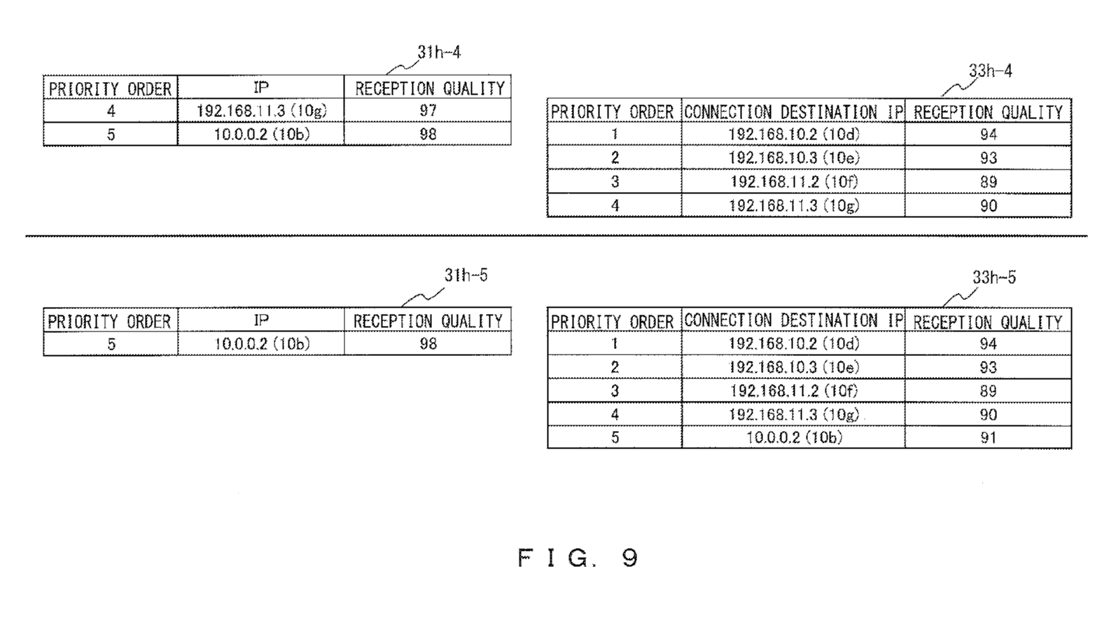

FIG. 8 and FIG. 9 illustrate examples of the connection destination candidate lists 31 and the quality lists 33. The connection destination candidate list 31h-1 illustrated in FIG. 8 is an example of the connection destination candidate list 31h generated by the obtainment unit 21h by using a received packet. In the connection destination candidate list 31h-1, the priority order, the IP address, and the reception quality of each of the obtained connection candidates are recorded.

Receiving information of a plurality of devices as the communication devices 10 that are to be candidates for a connection destination for the communication device 10h, the obtainment unit 21h determines, for each of the reported connection destination candidates, the priority order as a connection destination for the communication device 10h. In the example of the connection destination candidate list 31h-1, the obtainment unit 21h gives higher priority orders to the communication devices 10, as a communication device candidates, belonging to the same segment as the one including the communication device 10h than those given to the communication devices 10 belonging to other segments. Further, when a plurality of the communication devices 10 are candidates for a connection destination in the same segment, the communication devices 10 with higher reception quality are given higher priority orders. Note that the higher a priority order is, the smaller the value representing the priority order is. For segments not including the communication device 10, the obtainment unit 21h determines that the greater the bit length of a portion identical between the IP address of the communication device 10h and the network address of the segment is, the closer that segment is to the segment to which the communication device 10h belongs. For devices in a segment not including the communication device 10h, the obtainment unit 21h gives priority orders in such a manner that the closer to the communication device 10h the segment of the devices are, the higher priority orders given to such segments are. In the example illustrated in FIG. 8, the communication devices 10d, 10e and 10h are included in the same segment. Also, while the communication devices 10f and 10g are included in the same segment, both belong to a segment different from that including the communication device 10h. Further, the segment including the communication devices 10f and 10g is determined to be a segment that is closer to the communication device 10h than is the segment to which the communication device 10b belongs. Accordingly, for the candidates for a connection destination for the communication device 10h, the priority orders are set in the order of the communication devices 10d, 10e, 10f, 10g and 10b. Note that in FIG. 8 and FIG. 9, in order to facilitate understanding of the correspondence between the IP addresses and the communication devices 10, each IP address is followed by the numerical symbol, in parentheses, of the device to which that IP address is assigned.

Finishing the determination of priority orders, the comparison unit 23h selects the communication device 10 as a connection destination from among the devices in the connection destination candidate list 31h-1, and reports the selected communication device 10 to the quality calculation unit 22h and the connection process unit 25h. Hereinafter, a device selected as a connection destination upon the measurement of communication quality may also be referred to as a “target device”. The connection process unit 25h starts communication with a target device via the receiver 11h and the transmitter 12h. It is assumed for example that the comparison unit 23h has selected, as the target device, the communication device 10d having the highest priority order (priority order of 1) in the connection destination candidate list 31h-1. Then, the connection process unit 25h transmits to and receives from the communication device 10d via the transceiver 13h a control packet, and thereby connects the communication device 10h to the communication device 10d. The connection of the communication device 10h to the communication device 10d is illustrated as the communication device 10h-1 in FIG. 7.

The comparison unit 23h calculates a threshold to be compared with the reception quality with respect to the target device, by using equation (1), where Thn is a threshold used for the comparison with the reception quality, n is a numerical value representing the priority order associated with the device selected as the target device, RQn is reception quality in the device selected as the target device and a is a constant.

Thn=RQn−+×(n−1) (1)

Constant α is a constant used when the threshold is made smaller in response to determination that the communication quality with devices to which connections were attempted at that moment is lower than the threshold. Constant α is a positive value determined in accordance with the communication quality of the network. When for example the communication quality in the data distribution system is high, constant α is set to be relatively small, whereas the communication quality in the data distribution system is low, a large value is set as constant α. Note that (n−1) by which constant α is multiplied is the number of the communication devices 10 to which connections were attempted before the target device. Due to this, an increase in the number of the devices to which connections were attempted increases the value that is subtracted from the reception quality in the communication device 10 as the connection destination in the calculation of the threshold, making the threshold likely to be a small value.

Regarding the example illustrated as the communication device 10h-1 in FIG. 7, the target device is the communication device 10d with the highest priority order (priority order of 1) in the connection destination candidate list 31h-1. Accordingly, the comparison unit 23h uses reception quality (RQ1) associated with the communication device 10d and the number of the devices to which connections were attempted by the communication device 10h excluding the communication device 10d, so as to calculate, from equation (2), threshold (Th1) used for the comparison with reception quality.

Th1=RQ1−α×(1−1)=RQ1=100 (2)

From equation (2), threshold Th1 has the same value as the reception quality in the communication device 10d. In FIG. 7, the fact that threshold Th1 is equal to the reception quality in the communication device 10d is expressed by the arrow drawn from the reception quality in the communication device 10d toward the threshold used in the communication device 10h-1 and by the difference value (−0) between them. Because threshold Th1 is 100, when the reception quality in the communication device 10h receiving data from the communication device 10d is 100%, the comparison unit 23h determines that the connection state with respect to the communication device 10d is good enough to treat the communication device 10d as the data distribution source.

Meanwhile, when the communication device 10h has been connected to the communication device 10d, the communication device 10h starts to receive a data packet including distribution data and a control packet from the communication device 10d. The quality calculation unit 22h obtains via the receiver 11h the packet that was received from the communication device 10d, and calculates the reception quality. The calculation of the reception quality is conducted as described above by referring to FIG. 6. The quality calculation unit 22h records the obtained reception quality in the quality list 33h together with the information of the communication destination. In the example of the quality list 33h-1 illustrated in FIG. 8, the reception quality obtained with the communication device 10d serving as a connection destination is 94%.

The comparison unit 23h refers to the quality list 33h-1 (FIG. 8) so as to obtain the reception quality at the time of receiving data from the communication device 10d, and compares the obtained received value with threshold Th1. While threshold Th1 is 100%, the reception quality at the time of receiving the data from the communication device 10d is 94%. Accordingly, the comparison unit 23h determines that the connection state between the communication device 10d and the communication device 10h is not good enough to treat the communication device 10d as the data distribution source. Then, the comparison unit 23h deletes the communication device 10d from the connection destination candidate list 31h-1 so as to generate the connection destination candidate list 31h-2 (FIG. 8).

Next, it is assumed that the comparison unit 23h has selected, as the target device, the communication device 10e with the highest priority order (priority order of 2) in the connection destination candidate list 31h-2. It is also assumed that the communication device 10h has been connected to the communication device 10e as illustrated as the communication device 10h-2 in FIG. 7 through the process by the connection process unit 25h.

The comparison unit 23h uses reception quality (RQ2) obtained in the communication device 10e and the number of the devices to which connections were attempted by the communication device 10h excluding the communication device 10e, so as to calculate, from equation (3), threshold (Th2) used for the comparison with reception quality. Hereinafter, constant α is assumed to be 2.

$$\begin{matrix}Th 2 = RQ 2 - α \times ( n - 1 ) \\ = 99 - 2 \times ( 2 - 1 ) \\ = 97\end{matrix} \qquad ( 3 )$$

From equation (3), threshold Th2 is a value smaller than the reception quality in the communication device 10e. In FIG. 7, the fact that threshold Th2 is smaller than the reception quality in the communication device 10e is expressed by the arrow drawn from the reception quality in the communication device 10e toward the threshold used in the communication device 10h-2 and by the difference value (−2) between them. Because threshold Th2 is 97%, when the reception quality in the communication device 10h receiving data from the communication device 10e is equal to or higher than 97%, the comparison unit 23h determines that the connection state with respect to the communication device 10e is good enough to treat the communication device 10e as the data distribution source.

When the communication device 10h has been connected to the communication device 10e, the communication device 10h starts to receive a data packet including distribution data and a control packet from the communication device 10e. The quality calculation unit 22h calculates the reception quality. In this example, it is assumed that the reception quality in the communication device 10h receiving data from the communication device 10e is 93%. Because the quality calculation unit 22h records information of the obtained reception quality in the quality list 33h, the quality list 33h is updated from the state illustrated as the quality list 33h-1 to the state illustrated 33h-2 (FIG. 8).

The comparison unit 23h uses the quality list 33h-2 so as to obtain the reception quality at the time of receiving data from the communication device 10e, and compares the obtained received value with threshold Th2. While threshold Th2 is 97%, the reception quality at the time of receiving data from the communication device 10e is 93%. Accordingly, the comparison unit 23h determines that the connection state between the communication device 10e and the communication device 10h is not good enough to treat the communication device 10e as the data distribution source, and deletes the communication device 10e from the connection destination candidate list 31h-2. Thus, the connection destination candidate list 31h is updated as illustrated as the connection destination candidate list 31h-3 (FIG. 8).

Next, it is assumed that the comparison unit 23h has selected, as the target device, the communication device 10f having the highest priority order (priority order of 3) in the connection destination candidate list 31h-3. It is also assumed that the communication device 10h has been connected to the communication device 10f through the process by the connection process unit 25h.

The comparison unit 23h uses reception quality (RQ3) obtained in the communication device 10f and the number of the devices to which connections were attempted by the communication device 10h excluding the communication device 1f, so as to calculate, from equation (4), threshold (Th3) used for the comparison with reception quality.

$$\begin{matrix}Th 3 = RQ 3 - α \times ( n - 1 ) \\ = 100 - 2 \times ( 3 - 1 ) \\ = 96\end{matrix} \qquad ( 4 )$$

Because threshold Th3 is 96%, when the reception quality in the communication device 10h receiving data from the communication device 10f is equal to or higher than 96%, the comparison unit 23h determines that the connection state with respect to the communication device 10f is good enough to treat the communication device 10f as the data distribution source.

When the communication device 10h has been connected to the communication device 10f, the quality calculation unit 22h calculates the reception quality. In this example, it is assumed that the reception quality in the communication device 10h receiving data from the communication device 10f is 89%. Because the quality calculation unit 22h records information of the obtained reception quality in the quality list 33h, the quality list 33h is updated from the state illustrated as the quality list 33h-2 to the state illustrated as 33h-3 (FIG. 8).

The comparison unit 23h uses the quality list 33h-3 so as to obtain the reception quality at the time of receiving data from the communication device 10f, and compares the obtained received value with threshold Th3. While threshold Th3 is 96%, the reception quality at the time of receiving data from the communication device 10f is 89%. Accordingly, the comparison unit 23h determines that the connection state between the communication device 10f and the communication device 10h is not good enough to treat the communication device 10f as the data distribution source, and deletes the communication device 10f from the connection destination candidate list 31h-3. Thus, the connection destination candidate list 31h is updated as illustrated as the connection destination candidate list 31h-4 (FIG. 9).

Next, it is assumed that the comparison unit 23h has selected, as the target device, the communication device 10g with the highest priority order (priority order of 4) in the connection destination candidate list 31h-4 (FIG. 9). It is also assumed that the communication device 10h has been connected to the communication device 10g through the process by the connection process unit 25h.

The comparison unit 23h uses reception quality (RQ4) obtained by the communication device 10g and the number of the devices to which connections were attempted by the communication device 10h excluding the communication device 10g, so as to calculate, from equation (5), threshold (Th4) used for the comparison with reception quality.

$$\begin{matrix}Th 4 = RQ 4 - α \times ( n - 1 ) \\ = 97 - 2 \times ( 4 - 1 ) \\ = 91\end{matrix} \qquad ( 5 )$$

Because threshold Th4 is 91%, when the reception quality in the communication device 10h receiving data from the communication device 10g is equal to or higher than 91%, the comparison unit 23h determines that the connection state with respect to the communication device 10g is good enough to treat the communication device 10g as the data distribution source.

When the communication device 10h has been connected to the communication device 10g, the quality calculation unit 22h calculates the reception quality. In this example, it is assumed that the reception quality in the communication device 10h receiving data from the communication device 10g is 90%. Because the quality calculation unit 22h records information of the obtained reception quality in the quality list 33h, the quality list 33h is updated from the state illustrated as the quality list 33h-3 (FIG. 8) to the state illustrated as 33h-4 (FIG. 9).

The comparison unit 23h uses the quality list 33h-4 so as to compare the reception quality at the time of receiving data from the communication device 10g with threshold Th4. While threshold Th4 is 91%, the reception quality at the time of receiving data from the communication device 10g is 90%. Accordingly, the comparison unit 23h determines that the connection state between the communication device 10g and the communication device 10h is not good enough to treat the communication device 10g as the data distribution source, and deletes the communication device 10g from the connection destination candidate list 31h-4. Thus, the connection destination candidate list 31h is updated as illustrated as the connection destination candidate list 31h-5 (FIG. 9).

Next, it is assumed that the comparison unit 23h has selected, as the target device, the communication device 10b with the highest priority order (priority order of 5) in the connection destination candidate list 31h-5. It is also assumed that the communication device 10h has been connected to the communication device 10b through the process by the connection process unit 25h.

The comparison unit 23h uses reception quality (RQ5) obtained by the communication device 10b and the number of the devices to which connections were attempted by the communication device 10h excluding the communication device 10b, so as to calculate, from equation (6), threshold (Th5) used for the comparison with reception quality.

$$\begin{matrix}Th 5 = RQ 5 - α \times ( n - 1 ) \\ = 98 - 2 \times ( 5 - 1 ) \\ = 90\end{matrix} \qquad ( 6 )$$

From equation (6), threshold Th5 has a value smaller than the reception quality in the communication device 10b. In FIG. 7, the fact that threshold Th5 is a value smaller than the reception quality in the communication device 10b is expressed by the arrow drawn from the reception quality in the communication device 10b toward the threshold used in the communication device 10h-3 and by the difference value (−8) between them. Because threshold Th5 is 90%, when the reception quality in the communication device 10h receiving data from the communication device 10b is 90%, the comparison unit 23h determines that the connection state with the communication device 10b is good enough to treat the communication device 10b as the data distribution source.

When the communication device 10h has been connected to the communication device 10b, the quality calculation unit 22h calculates the reception quality. In this example, it is assumed that the reception quality in the communication device 10h receiving data from the communication device 10b is 91%. Because the quality calculation unit 22h records information of the obtained reception quality in the quality list 33h, the quality list 33h is updated from the state illustrated as the quality list 33h-4 (FIG. 9) to the state illustrated as 33h-5 (FIG. 9).

The comparison unit 23h uses the quality list 33h-5 so as to compare the reception quality at the time of receiving data from the communication device 10b with threshold Th5. While threshold Th5 is 90%, the reception quality at the time of receiving data from the communication device 10b is 91%. Accordingly, the comparison unit 23h determines that the connection state between the communication device 10b and the communication device 10h is good enough to treat the communication device 10b as the data distribution source. Thus, the comparison unit 23h outputs, to the setting unit 24h and the connection process unit 25h, the fact that a connection destination resulting in reception quality of at least threshold Th5, which is being used currently, has been found.

The setting unit 24h sets currently-used threshold Th5 as the detection threshold. The connection process unit 25h uses quality list 33h-5 so as to select, as a connection destination, the communication device 10 with the highest reception quality from among the devices for which reception quality was measured by that moment. The quality list 33h-5 indicates that the reception quality obtained with the communication device 10d serving as a connection destination is the highest among the devices for which reception quality was measured, and thus the connection process unit 25h selects the communication device 10d as a connection destination. The connection process unit 25h disconnects the communication with the communication device 10b that is being connected currently, and connects the communication device 10h to the communication device 10d.

After the determination of the connection destination, the quality calculation unit 22h continues the calculation of reception quality. Also, the connection process unit 25h compares reception quality calculated by the quality calculation unit 22h with the detection threshold so as to monitor whether or not the connection destination is appropriate. When reception quality calculated by the quality calculation unit 22h has fallen below the detection threshold, the connection process unit 25h determines to change the connection destination, and makes a request for the obtainment unit 21h to obtain candidates for a connection destination. In response to the request from the connection process unit 25h, the obtainment unit 21h obtains information of a connection destination similarly to the case of participating in the data distribution system, and accordingly the connection destination is changed through a process similar to the process explained above.

When the communication device 10h is connected to any of the communication devices 10, data packet including distributed data is output not only to the quality calculation unit 22h but also to the data process unit 26h. Because distributed data is processed in the data process unit 26h, the process results of the data is provided to the user of the communication device 10h on an as-needed basis via an output device such as a display device, a speaker device, etc. Further, when another communication device 10 has been connected to the communication device 10h, data packet including distributed data is output also to the relay process unit 27h. The relay process unit 27h transmits, via the transmitter 12h, the data packet including the distributed data to the communication device 10 that is connected to the communication device 10.

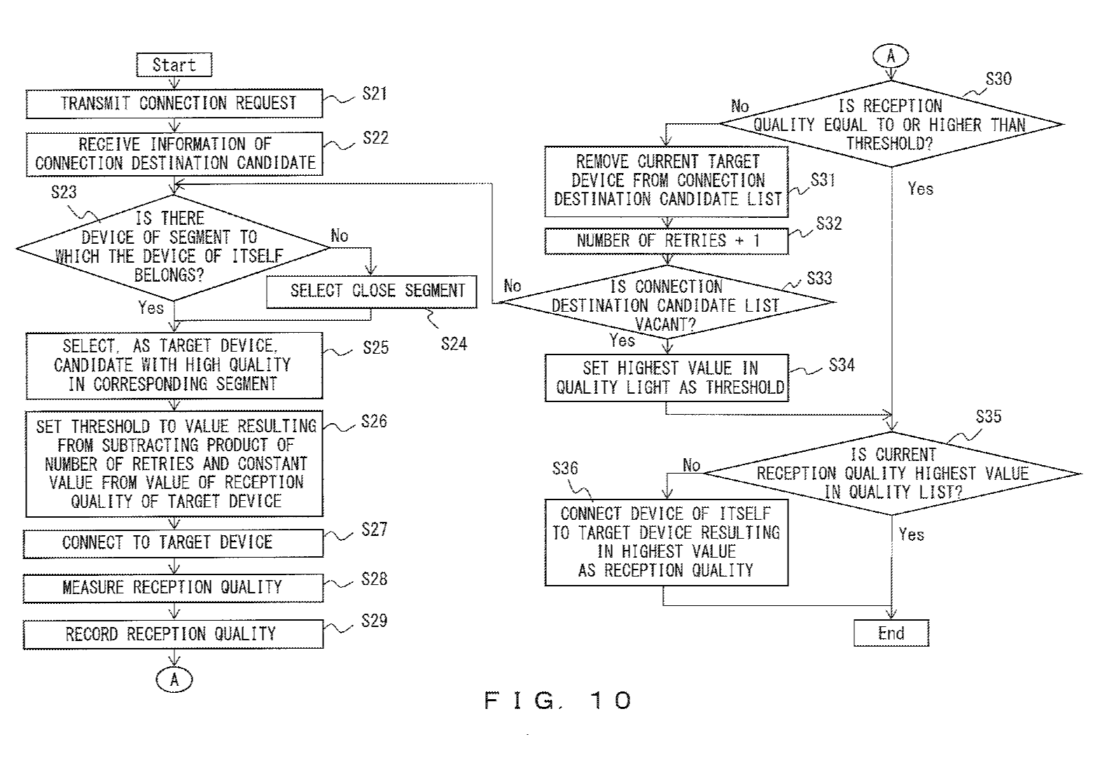

FIG. 10 is a flowchart explaining an example of a communication method according to an embodiment. Note that the procedures illustrated in FIG. 10 are an example and for example the orders of steps S31 and S32 may be changed. Also, step S35 may be omitted so as to cause a change so that the process of step S36 is performed in all cases. Also, the orders of steps S26 and S27 may be changed or steps S26 and S27 may be performed in parallel.

The obtainment unit 21 transmits a connection request toward the server 5 (step S21). The receiver 11 receives a packet including information of a connection destination candidate, and outputs it to the obtainment unit 21 (step S22). The obtainment unit 21 generates the connection destination candidate list 31 from the obtained information. The comparison unit 23 determines whether or not the connection destination candidate list 31 includes the communication device 10 that is included in the segment to which the device of the comparison unit 23 belongs (step S23). When the connection destination candidate list 31 does not include the communication device 10 that is included in the segment to which the device of the comparison unit 23 belongs, the comparison unit 23 selects the segment having the address with the longest portion identical to the address of the device of the comparison unit 23 (No in step S23, step S24). When the connection destination candidate list 31 includes the communication device 10 that is included in the segment to which the device of the comparison unit 23 belongs, the comparison unit 23 selects the segment to which the device of the comparison unit 23 belongs (Yes in step S23). The comparison unit 23 selects, as the target device, a candidate with high reception quality in the selected segment (step S25). The comparison unit 23 sets the threshold for the comparison with the reception quality to a value obtained by subtracting the product of the number of retries and a constant value (constant α) from the value of the reception quality of the target device (step S26). Note that the number of retries is the number of the devices to which connections were attempted before the connection of the target device that is being processed. The connection process unit 25 connects the device of the connection process unit 25 to the target device (step S27). Thereafter, the quality calculation unit 22 measures the reception quality and records the obtained value in the quality list 33 (steps S28 and S29). The comparison unit 23 determines whether or not the reception quality is equal to or higher than the threshold (step S30). When the reception quality is equal to or higher than the threshold, the connection process unit 25 determines whether or not the reception quality obtained currently is the highest value among the values of reception quality recorded in the quality list 33 (Yes in step S30, step S35). When the reception quality obtained currently is the highest among the values of reception quality recorded in the quality list 33, the connection process is terminated (Yes in step S35).

When the current reception quality is not the highest value in the quality list 33, the connection process unit 25 disconnects the communication with the current connection destination and also connects the target device that resulted in the highest value of reception quality to the device of the connection process unit 25 (No in step S35, step S36).

When it is determined in step S30 that the reception quality is not equal to or higher than the threshold, the comparison unit 23 removes the current target device from the connection destination candidate list 31, and increments the number of retries by one (steps S31 and S32). The comparison unit 23 returns to step S23 when the connection destination candidate list 31 is not vacant (No in step S33). When the connection destination candidate list 31 is vacant, the setting unit 24 sets the highest value in the quality list 33 as the threshold (Yes in step S33, step S34). After the process in step S34, the processes in and subsequent to step S35 are executed.

As described above, according to the method of the embodiment, a communication device 10 attempting to participate in the data distribution system changes the detection threshold used for determining whether or not to change a connection destination, in accordance with the number of the devices to which connections were attempted by that communication device 10 and the reception quality in the connection destination. Accordingly, the greater the number of devices to which connections were attempted by a communication device 10 before the final determination of a connection destination is, the smaller the detection threshold of that communication device 10 can be set to. Because the communication device 10 with a small value as the detection threshold does not easily have its reception quality fall below the detection threshold, its connection destination is not changed frequently during the distribution of data. In other words, according to the present embodiment, even a communication device 10 in a bad communication state with respect to other devices can prevent, by setting a small value as the detection threshold, a situation where too high a frequency of searching for connection destinations prevents that communication device 10 from receiving the distribution data. Also, the method according to the embodiment makes it possible for the communication device 10 to receive distribution data from a connection destination with relatively good communication state from among devices for which reception quality was measured.

In the above explanations, in order to facilitate understanding, an example has been used in which one communication device 10 newly participates in the data distribution system, whereas the communication device 10 having its reception quality below the detection threshold also determines a connection destination through a similar process.

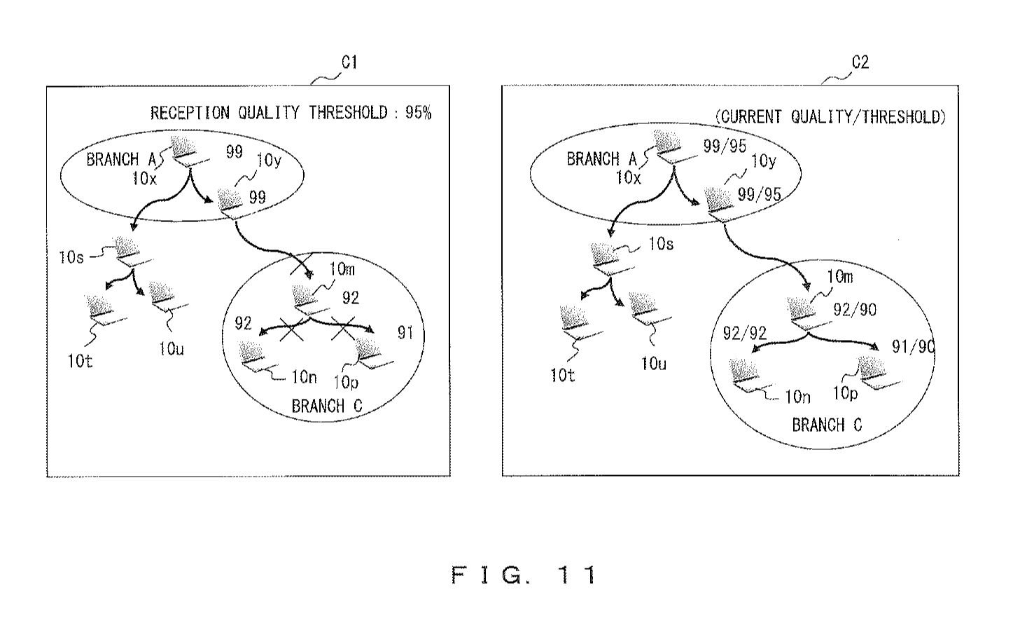

FIG. 11 illustrates an improved example of a data distribution system using the method according to the embodiment. Case C1 in FIG. 11 illustrates an example of a network in a case when a data distribution system has been formed across a plurality of branches of a company. The communication device 10x and the communication device 10y are located in branch A, while the communication device 10m, the communication device 10n and the communication device 10p are located in branch C. Note that it is assumed that none of the branches has the communication device 10s, 10t or 10u located in it. Note that in FIG. 11, the server 5 is not illustrated, however the communication device 10x may receive distribution data directly from the server 5 or may receive it via another device. The communication device 10x transfers the received data to the communication device 10s and the communication device 10y. The communication device 10s is transferring the received data to the communication device 10t and the communication device 10u, and the communication device 10y is transferring the received data to the communication device 10m. Further, it is assumed that the communication device 10m is transferring the data received from the communication device 10y to the communication device 10n and the communication device 10p.

It is assumed that a communication state has deteriorated between branches A and C during a communication being conducted on the route illustrated in case C1. It is assumed that the reception quality in each communication device 10 located in branch C is 92% for communication devices 10m and 10n and is 91% for communication device 10p when the communication state deteriorated. Also, the reception quality is assumed to be 99% for the communication devices 10x and 10y, which are located in branch A. When it is assumed in the situation illustrated in case C1 that the detection threshold is set to 95% in all of the communication devices 10, the reception quality is below the threshold for all of the communication devices 10m, 10c and 10p. Thus, the communication devices 10m, 10n and 10p start a process in which the communication with the current connection destination is disconnected and connection destinations are detected, from which distributed data is to be received.

It is assumed that the communication device 10m has made the threshold smaller in response to each increment in the number of times of connection failure by performing the process explained by referring to FIG. 5 through FIG. 10 and using the reception quality in a connection destination and the number of devices to which connections were attempted before the connection to the target device selected as a connection destination. It is also assumed that the above situation resulted in the establishment of a connection to the communication device 10y when the detection threshold in the communication device 10m has become 90%.

Case C2 in FIG. 11 illustrates a situation where the communication device 10m is connected to the communication device 10y with the detection threshold in the communication device 10m set to 90%. In case C2, the threshold and the reception quality that are being used appear for each of the devices located in branch A or C. Reception quality is on the left of a slash and the detection threshold is on the right of the slash. In the state illustrated as case C2 for example, “92/90” appears as the reception quality and the connection destination threshold for the communication device 10m because the communication device 10m has the reception quality of 92%. After the communication device 10m sets again the communication device 10y as the connection destination, the communication device 10n and the communication device 10p also search for connection destinations through a process similar to that performed by the communication device 10m. As a result, the communication device 10n has determined the communication device 10m as a connection destination when the detection threshold is 92%, and the reception quality has become 92% in the example illustrated as case C2. The communication device 10p has determined the communication device 10m to be a connection destination when the connection destination threshold is 90%, and the reception quality has become 91%.

As explained by referring to FIG. 11, the communication device 10m in a bad communication state can use the method according to the embodiment so as to lower the detection threshold, and thereby can receive data relatively stably by avoiding frequent searching for a connection destination. Also, because the communication device 10m is receiving data stably although the reception quality is not so good, it can also transfer data to the communication device 10n and the communication device 10p that are connected to the communication device 10m. As described above, according to the method of the embodiment, even a communication state is bad for the communication device 10 located on a boundary between bases, that communication device 10 lowers the detection threshold in accordance with the communication environment of itself so as to detect a connection destination that allows relatively stable obtainment of data. This avoids a situation where a bad communication state for a communication device 10 located on a boundary between bases prevents distribution of data to the entire base including that communication device 10, and thereby the efficiency of the data distribution can increase.

### Variation Example

Note that the embodiment is not limited to the above, and allows various modifications. Examples thereof will be described below.

In the explanations above, a threshold calculated by using the reception of a connection destination is compared only with the reception quality obtained during a connection to that connection destination, whereas a modification may be made in which one threshold may be compared with all values of reception quality in the quality list 33. When the reception quality for a connection destination is worse than reception quality with a different communication device 10, the above modification makes it possible to find a connection destination in a period of time shorter than in the above method.

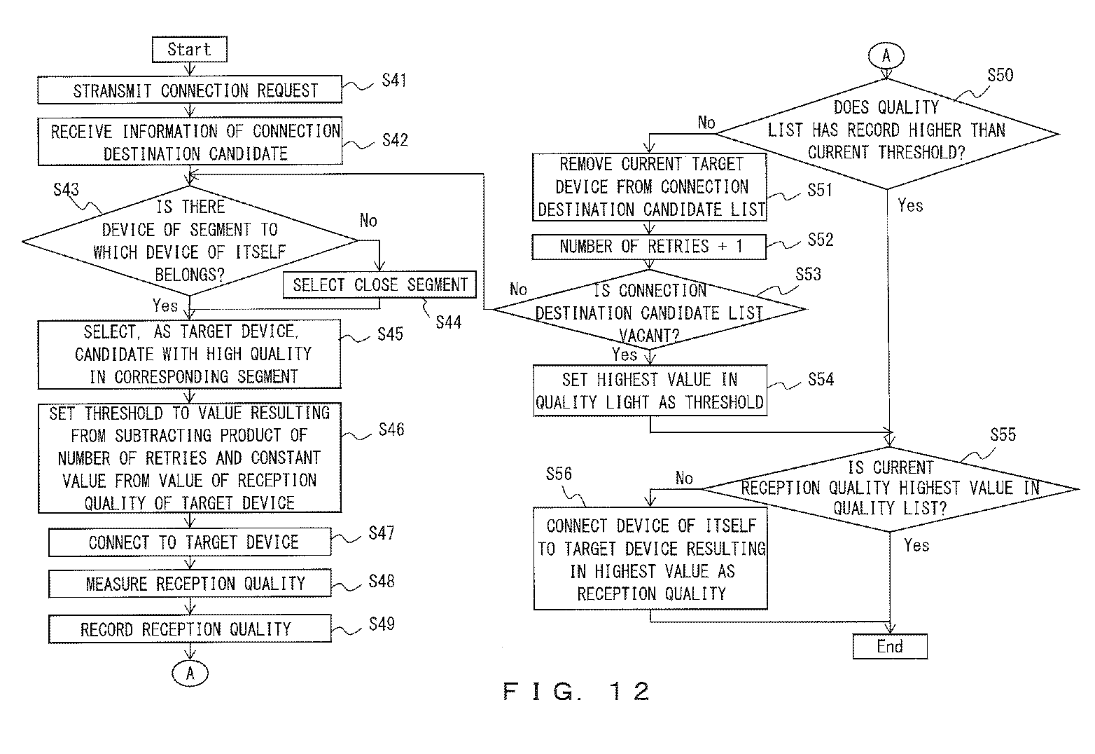

FIG. 12 is a flowchart explaining an example of a communication method according to a variation example. The processes in steps S41 through S49 are similar to those in steps S21 through S29, which were explained by referring to FIG. 10. Also, the processes in steps S51 through S56 are similar to those in steps S31 through S36, which were explained by referring to FIG. 10. In step S50, the comparison unit 23 determines whether or not the quality list 33 includes reception quality that is higher than the threshold being used for the current process. When the quality list 33 has reception quality higher than the threshold being used for the current process, the processes in and subsequent to step S55 are performed. When the quality list 33 does not have reception quality higher than the threshold being used for the current process, the processes in and subsequent to step S51 are performed.

Further, a different method may be used for determining a priority order in accordance with the implementation. For example, reception quality may be used for determining a priority order regardless of segments to which the communication devices 10 belong.

As described above, the method according to the embodiment realizes data distribution in high efficiency.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A connection method wherein
a first communication device that participates in a distribution system including a plurality of communication devices performs a process comprising:
comparing communication quality between a target communication device selected from among communication devices having a possibility of becoming a connection destination for the first communication device and the first communication device, with a quality threshold obtained as a function of data reception quality in the target communication device and a number of communication devices to which connections were attempted by the first communication device excluding the target communication device;
setting the quality threshold as a detection threshold for detecting an opportunity to change a connection destination when the communication quality is equal to or higher than the quality threshold; and
determining a second communication device with relatively high communication quality with the first communication device to be a connection destination used until the communication quality between the second and first communication devices falls below the detection threshold, from among communication devices having a possibility of becoming a connection destination for the first communication device.

2. The connection method according to claim 1, wherein
the first communication device performs, when searching for the connection destination, a process further comprising:
storing a first communication quality, which is communication quality between the second and first communication devices, when the first communication quality is lower than a first quality threshold calculated by using reception quality in the second communication device;
selecting a third communication device, which is different from the second communication device, as a new target communication device, and calculating a second quality threshold by using reception quality in the third communication device; and
setting the second quality threshold as the detection threshold when either second communication quality, which is communication quality between the third and first communication devices, or the first communication quality is equal to or higher than the second quality threshold.

3. The connection method according to claim 1, wherein
the first communication device
obtains a list of communication devices having a possibility of becoming a connection destination for the first communication device upon participating in the distribution system, and
selects a communication device with relatively high priority as a connection destination for the first communication device as the target communication device, from among communication devices, in the list, to which communications were not attempted by the first communication device.

4. The connection method according to claim 1, wherein
the first communication device subtracts a value directly proportional to a number of devices to which connections were attempted by the first communication device excluding the target communication device from the data reception quality in the target communication device, and thereby calculates a quality threshold used for a comparison with reception quality in the first communication device for case when the first communication device is connected to the target communication device.

5. A communication device that is capable of participating in a distribution system including a plurality of communication devices, the communication device comprising:
a processor that compares communication quality with a target communication device selected from among communication devices having a possibility of becoming a connection destination upon participating in the distribution system, with a quality threshold obtained as a function of data reception quality in the target communication device and a number of communication devices to which connections were attempted excluding the target communication device, and sets the quality threshold as a detection threshold for detecting an opportunity to change a connection destination when the communication quality is equal to or higher than the quality threshold; and
a network connection device that establishes a connection to a connection destination determined by the processor, wherein
the processor determines a different communication device with relatively high communication quality with the communication device to be a connection destination used until the communication quality between the different communication device and the communication device falls below the detection threshold, from among communication devices having a possibility of becoming a connection destination upon participating in the distribution system.

6. The communication device according to claim 5, further comprising
a memory configured to store a first communication quality, which is communication quality with a first communication device selected as the target communication device, when the first communication quality is lower than a first quality threshold calculated by using reception quality in the first communication device, wherein
the processor
selects a second communication device, which is different from the first communication device, as a new target communication device, and calculates a second quality threshold by using reception quality in the second communication device, and
sets the second quality threshold as the detection threshold when either second communication quality, which is communication quality with the second communication device, or the first communication quality is equal to or higher than the second quality threshold.

7. The communication device according to claim 5, wherein
the processor
obtains a list of communication devices having a possibility of becoming a connection destination upon participating in the distribution system, and
selects a communication device with relatively high priority as a connection destination for the first communication device as the target communication device, from among communication devices not selected as the target communication device in the list.

8. The communication device according to claim 5, wherein
the processor subtracts a value directly proportional to a number of devices to which connections were attempted excluding the target communication device from the data reception quality in the target communication device, and thereby calculates a quality threshold used for a comparison with reception quality obtained when a connection to the target communication is established.

9. A non-transitory computer-readable recording medium having stored therein a program for causing a first communication device that participates in a distribution system including a plurality of communication devices to execute a process comprising:
comparing communication quality between a target communication device selected from among communication devices having a possibility of becoming a connection destination for the first communication device and the first communication device, with a quality threshold obtained as a function of data reception quality in the target communication device and a number of communication devices to which connections were attempted by the first communication device excluding the target communication device;
setting the quality threshold as a detection threshold for detecting an opportunity to change a connection destination when the communication quality is equal to or higher than the quality threshold; and
determining a second communication device with relatively high communication quality with the first communication device to be a connection destination used until the communication quality between the second and first communication devices falls below the detection threshold, from among communication devices having a possibility of becoming a connection destination for the first communication device.

10. The recording medium according to claim 9, wherein
the program causes the first communication device to execute, when the first communication device searches for the connection destination, a process further comprising:
storing a first communication quality, which is communication quality between the second communication device selected as the target communication device and the first communication device, when the first communication quality is lower than a first quality threshold calculated by using reception quality in the second communication device;
selecting a third communication device, which is different from the second communication device, as a new target communication device, and calculating a second quality threshold by using reception quality in the third communication device; and
setting the second quality threshold as the detection threshold when either second communication quality, which is communication quality between the third and first communication devices, or the first communication quality is equal to or higher than the second quality threshold.
